(19) United States
(12) Patent Application Publication
(10) Pub. No.: US 2025/0322527 A1
(43) Pub. Date: Oct. 16, 2025

(54) IMAGE PROCESSING METHOD AND APPARATUS, COMPUTER DEVICE AND STORAGE MEDIUM

(71) Applicant: Beijing Zitiao Network Technology Co., Ltd., Haidian District (CN)

(72) Inventor: Yuanlue ZHU, Beijing (CN)

(21) Appl. No.: 19/250,737

(22) Filed: Jun. 26, 2025

Related U.S. Application Data
(63) Continuation of application No. PCT/CN2023/136795, filed on Dec. 6, 2023.

(30) Foreign Application Priority Data
Dec. 26, 2022 (CN) 202211675616.X

(51) Int. Cl. G06T 7/11; G06T 5/30; G06T 5/60; G06T 7/174

(52) U.S. Cl. CPC G06T 7/11; G06T 5/30; G06T 5/60; G06T 7/174; G06T 2207/20081; G06T 2207/20084; G06T 2207/20221; G06T 2207/30196

(57) ABSTRACT

Provided in the present disclosure are an image processing method and apparatus, a computer device and a storage medium. The method comprises: acquiring an original image to be processed; adjusting the original image to be processed to generate a reference original image; determining target region information in the reference original image; and fusing a target region image in the reference original image that matches the target region information, with the original image to be processed, to generate a target original image.

### CROSS REFERENCE TO RELATED APPLICATIONS

The present application is a continuation application of International Application No. PCT/CN2023/136795, as filed on Dec. 6, 2023, which is based on and claims priority of the Chinese Patent Application No. 202211675616.X, filed on Dec. 26, 2022, the disclosure of both applications are incorporated by reference herein in their entireties.

### TECHNICAL FIELD

The present disclosure relates to the technical field of image processing, and in particular to an image processing method and apparatus, a computer device and a storage medium.

### BACKGROUND

With the development of artificial intelligence (AI) technology, neural networks have been widely used in image processing scenarios, such as AI Beauty. AI beauty generates beautified images by performing beautification treatment, makeup treatment and the like on images.

### SUMMARY

Embodiments of the present disclosure at least provide an image processing method and apparatus, a computer device, and a storage medium.

In a first aspect, some embodiments of the present disclosure provide an image processing method, comprising:
acquiring an original image to be processed;
adjusting the original image to be processed to generate a reference original image;
determining target region information in the reference original image; and
fusing a target region image in the reference original image that matches the target region information, with the original image to be processed, to generate a target original image.

In some implementations, the determining target region information in the reference original image comprises:
performing region segmentation processing on the reference original image and the original image to be processed respectively, and generating a first segmented image corresponding to the reference original image and a second segmented image corresponding to the original image to be processed; wherein, in the first segmented image and the second segmented image, pixel values corresponding to different semantic regions are different;
determining, based on the first segmented image and the second segmented image, the target region information of a region where a hairline is located in the reference original image.

In some implementations, the determining, based on the first segmented image and the second segmented image, the target region information of a region where a hairline is located in the reference original image comprises:
adjusting pixel values of the pixel points located below a target reference line in the first segmented image and the second segmented image respectively to a preset value, to obtain an adjusted first segmented image and an adjusted second segmented image, wherein the target reference line is determined based on a target part;
subjecting pixel values at corresponding pixel positions in the adjusted first segmented image and the adjusted second segmented image to subtraction, to generate a deviation image including the region where a hairline is located;
determining, based on the deviation image, the target region information of the region where a hairline is located in the reference original image.

In some implementations, the determining, based on the deviation image, the target region information of the region where a hairline is located in the reference original image comprises:
performing dilation processing on the region where a hairline is located in the deviation image, to generate a processed deviation image;
generating a mask image according to the first segmented image;
generating a hairline segmentation image based on the processed deviation image and the mask image;
determining, based on the hairline segmentation image, the target region information of the region where a hairline is located in the reference original image.

In some implementations, after the generating a hairline segmentation image, the method further comprises:
determining, based on a region where facial features are located in the first segmented image, a target image region including the region where facial features are located, and generating, based on the target image region, a processed first segmented image; wherein, in the processed first segmented image, pixel values at pixel positions corresponding to the target image region are zero;
generating an adjusted hairline segmentation image based on the processed first segmented image and the hairline segmentation image;
the determining, based on the hairline segmentation image, the target region information of the region where a hairline is located in the reference original image comprises:
   determining, based on the adjusted hairline segmentation image, the target region information of the region where a hairline is located in the reference original image.

In some implementations, before the fusing a target region image in the reference original image that matches the target region information, with the original image to be processed, the method further comprises:
determining hair color information in the original image to be processed;
adjusting a hair color of the reference original image based on the hair color information, to generate an adjusted reference original image;
the fusing a target region image in the reference original image that matches the target region information, with the original image to be processed, to generate a target original image, comprises:
   fusing the target region image in the adjusted reference original image that matches the target region information, with the original image to be processed, to generate the target original image.

In some implementations, the adjusting the original image to be processed to generate a reference original image comprises: adjusting the original image to be processed using a target neural network obtained by performing training, to generate the reference original image;
the target neural network is obtained by performing training according to the steps of:
   acquiring a plurality of candidate original image pairs, wherein each of the candidate original image pairs includes: a first candidate original image, and a second candidate original image obtained after performing hairline adjustment on the first candidate original image;
   for each of the candidate original image pairs, determining a first reconstructed image of the first candidate original image and a second reconstructed image of the second candidate original image in the candidate original image pair; and fusing a region image of a region where a hairline is located in the second reconstructed image with the first reconstructed image, to generate a third reconstructed image, and determining the first reconstructed image and the third reconstructed image as a reconstructed image pair;
   determining each of the reconstructed image pairs as a training sample;
   training the neural network to be trained using the training samples, to obtain the target neural network.

In some implementations, the determining a first reconstructed image of the first candidate original image and a second reconstructed image of the second candidate original image in the candidate original image pair comprises:
determining first noise data of the first candidate original image and second noise data of the second candidate original image;
generating the second reconstructed image based on the second noise data; and
generating the first reconstructed image based on the first noise data; or, determining noise difference data between the second noise data and the first noise data, performing difference processing on the first noise data and the noise difference data to obtain third noise data, and generating the first reconstructed image using the third noise data.

In a second aspect, some embodiments of the present disclosure further provide an image processing apparatus, comprising:
an acquisition module, configured to acquire an original image to be processed;
a first generation module, configured to adjust the original image to be processed to generate a reference original image;
a determination module, configured to determine target region information in the reference original image; and
a second generation module, configured to fuse a target region image in the reference original image that matches the target region information, with the original image to be processed, to generate a target original image.

In a third aspect, some embodiments of the present disclosure further provide a computer device, comprising: a processor, a memory and a bus, wherein the memory stores machine-readable instructions executable by the processor, and when the computer device is running, the processor and the memory communicate via the bus, and the machine-readable instructions, when executed by the processor, perform the steps of the first aspect, or of any possible implementation of the first aspect described above.

In a fourth aspect, some embodiments of the present disclosure further provide a computer-readable storage medium having a computer program stored thereon, which, when executed by a processor, performs the steps of the first aspect, or of any possible implementation of the first aspect described above.

Some embodiments of the present disclosure provide an image processing method and apparatus, a computer device, and a storage medium, wherein in the method, by adjusting the acquired original image to be processed through a target neural network, a reference original image is generated. In the present disclosure, by determining target region information in the reference original image (e.g., target region information of a region where a hairline is located) and fusing a target region image in the reference original image that matches the target region information, with the original image to be processed, a target original image is generated, wherein the target original image is a hairline-adjusted image.

In order to make the above-mentioned objectives, features and advantages of the present disclosure more obvious and easy to understand, preferred embodiments are specifically cited below and described in detail with reference to the accompanying drawings.

### BRIEF DESCRIPTION OF THE DRAWINGS

In order to more clearly illustrate the technical solutions of the embodiments of the present disclosure, the drawings required for use in the embodiments will be briefly introduced below. The drawings herein are incorporated into the specification and constitute a part of this specification. These drawings show embodiments consistent with the present disclosure and are used together with the specification to illustrate the technical solutions of the present disclosure. It should be understood that the following drawings only illustrate certain embodiments of the present disclosure and therefore should not be regarded as limiting the scope. For those skilled in the art, other related drawings can be obtained based on these drawings without paying any creative work.

FIG. 1 shows a flow chart of an image processing method provided by an embodiment of the present disclosure;

FIG. 2 shows a schematic diagram of fusing a reference original image and an original image to be processed in the image processing method provided by an embodiment of the present disclosure;

FIG. 3 shows a schematic diagram of a second reconstructed image and first reconstructed images generated in two ways in the image processing method provided by an embodiment of the present disclosure;

FIG. 4 shows a schematic diagram of an image processing apparatus provided by an embodiment of the present disclosure;

FIG. 5 shows a schematic structural diagram of a computer device provided by an embodiment of the present disclosure.

### DETAILED DESCRIPTION

In order to make the objectives, technical solutions and advantages of the embodiments of the present disclosure clearer, the technical solutions in the embodiments of the present disclosure will be clearly and completely described below in conjunction with the drawings in the embodiments of the present disclosure. Obviously, the described embodiments are only part of the embodiments of the present disclosure, rather than all the embodiments. The components of the embodiments of the present disclosure generally described and illustrated in the figures herein may be arranged and designed in a variety of different configurations. Therefore, the following detailed description of the embodiments of the present disclosure provided in the accompanying drawings is not intended to limit the scope of the present disclosure as claimed, but is merely representative of selected embodiments of the present disclosure. Based on the embodiments of the present disclosure, all other embodiments obtained by those skilled in the art without making any creative work shall fall within the scope of protection of the present disclosure.

With the development of artificial intelligence (AI) technology, neural networks have been widely used in image processing scenarios, such as AI beauty. AI beauty generates beautified images by performing beautification treatment, makeup treatment and the like on images.

As more and more user images have a problem of high hairline, supplementing the hairline has become one of the needs for image beauty. Therefore, it is particularly important to propose an image processing method that meets the above need. In an embodiment of the present disclosure, the image includes a facial image.

Based on this, the present disclosure provides an image processing method, which may adjust an acquired original image (e.g., a facial image) to be processed using a target neural network to generate a reference original image, and for example, a specific part such as a hairline may be adjusted. There exists a problem that not only region information of a region where the specific part (such as a hairline) is located in the reference original image is different from the original image to be processed, but other region information such as background information, user's facial features, skin color, hair color, etc. will also be different from the original image to be processed, resulting in a poor display effect of the reference original image. In order to alleviate the above problem, the present disclosure determines target region information in the reference original image, such as the region information of the region where the hairline is located, and fuses a target region image in the reference original image that matches the target region information, with the original image to be processed, to generate a target original image, which is a hairline-adjusted image, so that while ensuring that an image of other regions in the target original image other than the region of the specific part such as the hairline is the same as the original image to be processed, the adjustment on the specific part is realized and the effect of hairline adjustment is improved, thus attaining the better display effect of the target original image.

It should be noted that similar reference numerals and letters denote similar items in the following drawings, and therefore, once an item is defined in one drawing, further definition and explanation thereof is not required in subsequent drawings.

The term “and/or” herein only describes an association relationship, indicating that there may exist three relationships; for example, A and/or B may mean: A exists alone, A and B exist simultaneously, and B exists alone. In addition, the term “at least one” herein means any combination of at least two of any one or more of a plurality of types; for example, including at least one of A, B, and C may mean including any one or more elements selected from a set consisting of A, B, and C.

It is understandable that before using the technical solutions disclosed in the embodiments of the present disclosure, the type, scope of use, scenario of use, etc. of the personal information involved in the present disclosure should be informed to the user and the user's authorization should be obtained in an appropriate manner in accordance with relevant laws and regulations.

For example, in response to receiving an active request from a user, prompt information is sent to the user to explicitly prompt the user that the operation requested to be performed will require obtaining and using the user's personal information. Thus, according to the prompt information, the user can choose by him-or her-self whether to provide his or her personal information to software or hardware such as an electronic device, application, server or storage medium that executes the operation in the technical solutions of the present disclosure.

As an optional but non-limiting implementation, in response to receiving an active request from the user, the prompt information may be sent to the user in the form of a pop-up window, for example, in which the prompt information may be presented in text form. In addition, the pop-up window may also carry a selection control for the user to choose to “agree” or “disagree” to provide his or her personal information to the electronic device.

It is understandable that the above process of notifying and obtaining the user's authorization is merely illustrative and do not constitute a limitation on the implementation of the present disclosure, and other methods that comply with the relevant laws and regulations may also be applied to the implementation of the present disclosure.

To facilitate understanding of this embodiment, an image processing method disclosed in the embodiment of the present disclosure is first introduced in detail, and the execution subject of the image processing method is generally a computer device with certain computing capabilities.

The image processing method provided by an embodiment of the present disclosure is described below by taking the execution subject as a server as an example.

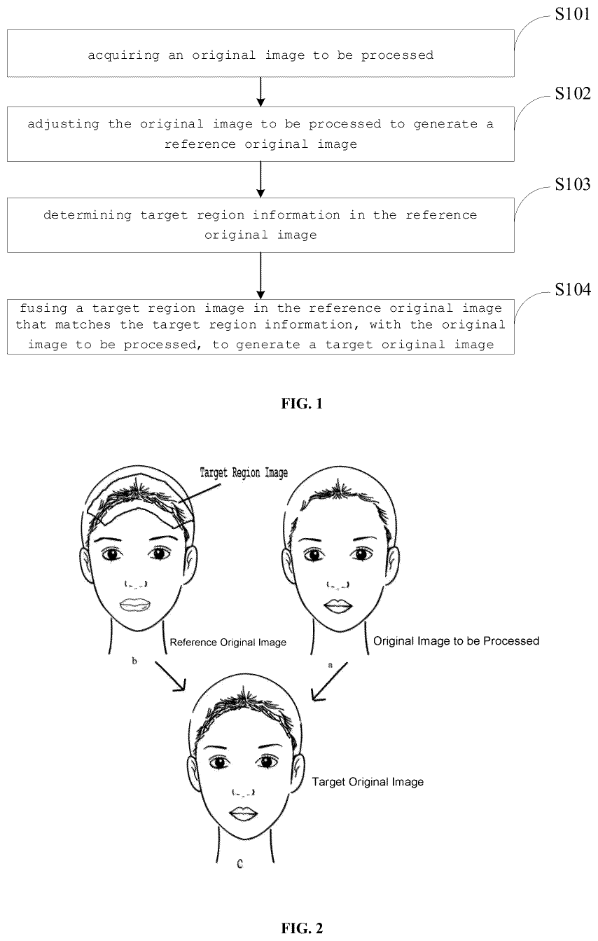

Referring to FIG. 1, which is a flow chart of an image processing method provided by an embodiment of the present disclosure, the method comprises S101 to S104:
S101: acquiring an original image to be processed;
S102: adjusting the original image to be processed to generate a reference original image;
S103: determining target region information in the reference original image;
S104: fusing a target region image in the reference original image that matches the target region information, with the original image to be processed, to generate a target original image. S101 to S104 are described in detail below.

For S101 and S102:

The original image to be processed may be an original image of any user. In implementation, it is possible to adjust the original image to be processed in response to an adjustment operation, to generate a reference original image, or to adjust the original image to be processed using a target neural network obtained by performing training, to generate a reference original image, that is, the acquired original image to be processed is input into the target neural network, and adjusted using the target neural network, to generate the reference original image; for example, it is possible to adjust a hairline of the original image to be processed, and then the reference original image can be an image with a supplemented hairline (that is, the hairline is moved down). The target neural network is a trained network for hairline adjustment, and the network structure of the target neural network can be set as needed, for example, the target neural network can be a pix2pix network.

For S103:

Illustratively, the region where the hairline is located may be labeled in the reference original image in response to a manual labeling operation, and then based on a labeling result, the target region information in the reference original image, such as target region information of the region where the hairline is located, may be determined. Alternatively, a position of eyebrows in the reference original image may be determined, and based on the position, a labeled region of the reference original image may be determined according to a preset shape and size, and the labeled region may be determined as the region where the hairline is located, thereby obtaining the target region information of the region where the hairline is located in the reference original image, wherein the target region information may be position information of the region where the hairline is located in the reference original image.

In some implementations, the determining target region information in the reference original image comprises:
Step a1: performing region segmentation processing on the reference original image and the original image to be processed, respectively, and generating a first segmented image corresponding to the reference original image and a second segmented image corresponding to the original image to be processed; wherein, in the first segmented image and the second segmented image, pixel values corresponding to different semantic regions are different;

Step a2: determining, based on the first segmented image and the second segmented image, the target region information of the region where the hairline is located in the reference original image.

In implementation, region segmentation processing may be performed on the reference original image, to generate the first segmented image; for example, region segmentation processing may be performed on the reference original image using a parsing tool, to generate the first segmented image. Alternatively, region segmentation processing may also be performed on the reference original image using a segmentation neural network, to generate the first segmented image. Similarly, region segmentation processing may be performed on the original image to be processed in the same way, to generate the second segmented image. In the first segmented image and the second segmented image, pixel values corresponding to different semantic regions are different, an image size of the first segmented image may be consistent with that of the reference original image, and an image size of the second segmented image may be consistent with that of the original image to be processed.

For example, a pixel value corresponding to a region where the eyebrows are located in the first segmented image may be s₁, a pixel value corresponding to a region where the eyes are located may be s₂, a pixel value corresponding to a region where the nose is located may be s₃, a pixel value corresponding to a region where the lips are located may be s₄, a pixel value corresponding to a region where the hair is located may be s₅, and a pixel value corresponding to other regions on the entire region other than the above-mentioned parts may be s₆.

Then, the target region information of the region where the hairline is located in the reference original image may be determined according to the first segmented image and the second segmented image. For example, with the nose as a reference, the first segmented image and the second segmented image may be overlapped, a hair deviation region corresponding to a hair region in the first segmented image and the second segmented image may be determined, and the hair deviation region may be determined as the region where the hairline is located in the reference original image, thus obtaining the target region information of the region where the hairline is located.

Here, by generating the first segmented image and the second segmented image, different semantic regions in the first segmented image and the second segmented image correspond to different pixel values, and then based on the first segmented image and the second segmented image, the target region information of the region where the hairline is located in the reference original image may be determined more conveniently.

In some implementations, in step a2, the determining, based on the first segmented image and the second segmented image, the target region information of a region where a hairline is located in the reference original image specifically comprises:
Step a21: adjusting pixel values of the pixel points located below a target reference line in the first segmented image and the second segmented image respectively to a preset value, to obtain an adjusted first segmented image and an adjusted second segmented image, wherein the target reference line is determined based on a target part;
Step a22: subjecting pixel values at corresponding pixel positions in the adjusted first segmented image and the adjusted second segmented image to subtraction, to generate a deviation image including the region where a hairline is located;
Step 23: determining, based on the deviation image, the target region information of the region where a hairline is located in the reference original image.

Considering that the hairline is generally located in the forehead region, in order to more accurately determine the region where the hairline is located and reduce the adjustment on the region where the facial features are located, a target reference line may be set based on a target part such as an eyebrow part, an eye part, or the like, that is, a horizontal line is drawn at the position where the target part is located, as the target reference line. Then, pixel values of the pixel points located below the target reference line in the first segmented image and the second segmented image are adjusted to a preset value, such as 0, 1, etc., thus obtaining the adjusted first segmented image and the adjusted second segmented image.

Thereafter, pixel values at corresponding pixel positions in the adjusted first segmented image and the adjusted second segmented image are subjected to subtraction, to generate a deviation image including the region where the hairline is located. For example, a pixel value of a pixel point located in the first row and first column on the adjusted first segmented image and a pixel value of a pixel point located in the first row and first column on the adjusted second segmented image may be subjected to subtraction, thus obtaining a pixel difference, which is a pixel value of the pixel point located in the first row and first column on the deviation image; similarly, pixel differences corresponding to respective pixel positions may be obtained, thus obtaining a deviation image.

When the deviation image and the reference original image have the same image size, the region information of the region where the hairline is located in the deviation image may be determined as the target region information of the region where the hairline is located in the reference original image.

Considering that the difference between the adjusted first segmented image and the adjusted second segmented image is the difference in the region where the hair is located, by subjecting the pixel values at the corresponding pixel positions in the adjusted first segmented image and the adjusted second segmented image to subtraction, a deviation image including the region where the hairline is located can be generated, and then based on the deviation image, the target region information of the region where the hairline is located in the reference original image can be determined more simply and efficiently.

In some implementations, the determining, based on the deviation image, the target region information of the region where a hairline is located in the reference original image comprises:
Step b1: performing dilation processing on the region where a hairline is located in the deviation image, to generate a processed deviation image;
Step b2: generating a mask image according to the first segmented image; generating a hairline segmentation image based on the processed deviation image and the mask image;
Step b3: determining, based on the hairline segmentation image, the target region information of the region where a hairline is located in the reference original image.

In order to subsequently generate an image with a better hairline adjustment effect, dilation processing may be performed on the region where a hairline is located in the deviation image, to generate a processed deviation image. In implementation, dilation processing may be performed on the deviation image using a convolution operation of a convolution kernel, to obtain the processed deviation image; alternatively, erosion and dilation processing may be performed on the region where the hairline is located in the deviation image, to generate the processed deviation image.

Considering that the region where the hairline is located is located on the hair of a human face, in order to alleviate the interference of the regions other than the face region and the hair region and more accurately determine the region where the hairline is located, a mask image may be generated according to the first segmented image; in the mask image, the pixel values of the face region and the hair region are 1, and the pixel values of the regions other than the face and the hair are 0. The pixel values at the corresponding pixel positions in the processed deviation image and the mask image are multiplied together, to generate the hairline segmentation image.

Then, based on the hairline segmentation image, the target region information of the region where the hairline is located in the reference original image is determined; for example, region information of the region where the hairline is located in the hairline segmentation image may be determined as the target region information.

Here, the mask image is generated according to the first segmented image, and since the pixel values of the regions other than the face and the hair in the mask image are zero, the pixel values at the corresponding pixel positions in the mask image and the processed deviation image are multiplied together, so that pixel information of the regions other than the face and the hair in the processed deviation image can be filtered out, thereby subsequently determining the target region information more accurately.

In some implementations, after the generating a hairline segmentation image, the method further comprises: determining, based on a region where facial features are located in the first segmented image, a target image region including the region where facial features are located, and generating, based on the target image region, a processed first segmented image; wherein, in the processed first segmented image, pixel values at the pixel positions corresponding to the target image region are zero; generating an adjusted hairline segmentation image based on the processed first segmented image and the hairline segmentation image;

The determining, based on the hairline segmentation image, the target region information of the region where a hairline is located in the reference original image comprises: determining, based on the adjusted hairline segmentation image, the target region information of the region where a hairline is located in the reference original image.

After the hairline segmentation image is generated, considering that dilation processing is performed on the region where a hairline is located in the deviation image, as a result of which, the region where a hairline is located may occupy a larger forehead region, the following problem may be caused in subsequently fusing the target region image in the reference original image with the original image to be processed: pixel information of the forehead region in the obtained target original image is more matched with the reference original image, rather than with the original image to be processed; due to the deviation between the reference original image and the original image to be processed, there is a deviation between the forehead regions of the target original image and the original image to be processed, resulting in poor display effect of the target original image.

In order to alleviate the above problem, the present disclosure determines, based on the region where facial features are located in the first segmented image, the target image region including the region where facial features are located. For example, erosion and dilation processing may be performed on the region where facial features are located in the first segmented image, to generate a dilated facial-features region, i.e., to obtain the target image region including the region where facial features are located. Then, the processed first segmented image is generated based on the target image region, wherein the pixel values at the pixel positions corresponding to the target image region in the first segmented image are zero; then, the pixel values at the corresponding pixel positions in the processed first segmented image and the hairline segmentation image are multiplied together, to generate the adjusted hairline segmentation image, thereby subsequently determining the target region information of the region where a hairline is located in the reference original image based on the adjusted hairline segmentation image, so that the determined target region information may occupy less forehead region, and a target original image with better display effect can be generated later.

For S104:

After the target region information is obtained, the target region image matching the target region information may be determined from the reference original image, and the target region image may be a region image of the region where a hairline is located in the reference original image. The target region image is then fused with the original image to be processed to generate the target original image. For example, a local image matching the target region information may be determined from the original image to be processed, and by replacing the local image with the target region image, the target original image is generated.

Referring to FIG. 2, FIG. 2 at a shows an original image to be processed, FIG. 2 at b shows a reference original image and a target region image, and by fusing the original image to be processed with the target region image, a target original image is obtained, which is as shown in FIG. 2 at c.

In specific implementation, the target original image may be generated by using the hairline segmentation image (or the adjusted hairline segmentation image), the original image to be processed and the target region image, wherein the hairline segmentation image is a mask image (mask). For example, the target original image may be generated according to the following formula:

$$blend\_img = img\_x * ( 1. - mask ) + img\_y * mask ,$$

where mask is a pixel value of a pixel position in the mask image, img_x is a pixel value of the same pixel position in the original image to be processed, img_y is a pixel value of the same pixel position in the reference original image, and blend_img is a pixel value of the same pixel position in the target original image.

Considering that after generating the reference original image by performing hairline adjustment on the original image to be processed using the target neural network, the hair color of the reference original image may be different from that of the original image to be processed, in order to ensure that the hair color of the generated target original image is consistent with that of the original image to be processed, the hair color of the reference original image may be adjusted before image fusion.

In specific implementation, before the fusing a target region image in the reference original image that matches the target region information, with the original image to be processed, the method further comprises: determining hair color information in the original image to be processed; adjusting a hair color of the reference original image based on the hair color information, to generate an adjusted reference original image;

The fusing a target region image in the reference original image that matches the target region information, with the original image to be processed, to generate a target original image, comprises: fusing the target region image in the adjusted reference original image that matches the target region information, with the original image to be processed, to generate the target original image.

The hair color information in the original image to be processed is determined; for example, the hair color of the original image to be processed may be determined by using histogram statistics, and then the hair color of the original image to be processed may be migrated to the reference original image, to generate the adjusted reference original image. Thereafter, the target region image matching the target region information may be determined from the adjusted reference original image, and then the target region image may be fused with the original image to be processed, to generate the target original image.

In implementation, the original image to be processed may be adjusted using a target neural network obtained by performing training, to generate the reference original image. The present disclosure, before being implemented, may further comprise a step of training and obtaining the target neural network. The following is an exemplary description of the process of training and obtaining the target neural network.

In some implementations, training and obtaining the target neural network comprises:
Step c1: acquiring a plurality of candidate original image pairs, wherein each of the candidate original image pairs includes: a first candidate original image, and a second candidate original image obtained after performing hairline adjustment on the first candidate original image;
Step c2: for each of the candidate original image pairs, determining a first reconstructed image of the first candidate original image and a second reconstructed image of the second candidate original image in the candidate original image pair; and fusing a region image of a region where a hairline is located in the second reconstructed image with the first reconstructed image, to generate a third reconstructed image, and determining the first reconstructed image and the third reconstructed image as a reconstructed image pair;
Step c3: determining each of the reconstructed image pairs as a training sample;
Step c4: training the neural network to be trained using the training samples, to obtain the target neural network.

In step c1, each candidate original image pair includes a first candidate original image and a second candidate original image; wherein the first candidate original image may be any original image, and the second candidate original image may be obtained after performing hairline adjustment on the first candidate original image. In implementation, hairline adjustment may be performed on the first candidate original image in response to a manual operation, to generate the second candidate original image. Alternatively, a pix2pix network may be trained using samples to obtain a trained pix2pix network, which is used to adjust a hairline of an input image; the first candidate original image is then input into the trained pix2pix network to generate the second candidate original image; since the pix2pix network performs subtle adjustment on the input image, the trained pix2pix network may be used to perform multiple adjustments on the first candidate original image, to generate the second candidate original image.

In step c2, since there are heavy hairline adjustment traces in the second candidate original image, the second candidate original image is unnatural and the display effect is poor. In order to obtain an image with a more natural hairline adjustment, the first candidate original image and the second candidate original image may be reconstructed. In implementation, for each candidate original image pair, the first candidate original image and the second candidate original image may be reconstructed using a neural network, to generate a first reconstructed image and a second reconstructed image. For example, image reconstruction may be performed using a neural network consisting of an encoder for editing (e4e) tool and a stylegan2 network; specifically, e4e can convert an input image into noise data, and then input the noise data into stylegan2, thus generating a reconstructed image corresponding to the input image.

In specific implementation, a first reconstructed image of the first candidate original image and a second reconstructed image of the second candidate original image in the candidate original image pair may be determined according to the following steps:
Step c21: determining first noise data of the first candidate original image and second noise data of the second candidate original image;
Step c22: generating the second reconstructed image based on the second noise data; and
Step c23: generating the first reconstructed image based on the first noise data; or, determining noise difference data between the second noise data and the first noise data, performing difference processing on the first noise data and the noise difference data to obtain third noise data, and generating the first reconstructed image using the third noise data.

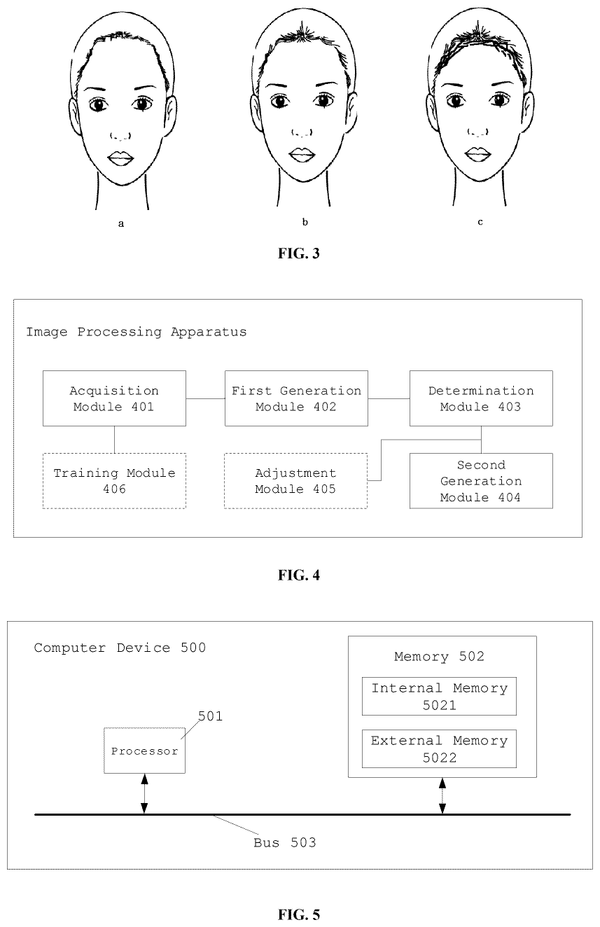

Illustratively, an input image may be converted into noise data using an image-to-noise tool. For example, the first candidate original image may be processed using e4e to generate first noise data, and the second candidate original image may be processed using e4e to generate second noise data. The second noise data may then be input into the stylegan2 network to generate a second reconstructed image, as shown in FIG. 3 at c.

In one approach, the first noise data may be input into the stylegan2 network to generate the first reconstructed image, as shown in FIG. 3 at b. In another approach, considering that after generating a reconstructed image by directly inputting the first noise data into the stylegan2 network, the hairline position of the reconstructed image is slightly different from the hairline position of the second reconstructed image, in order to alleviate the above problem, noise difference data between the second noise data and the first noise data may be determined, that is, the first noise data is subtracted from the second noise data to generate the noise difference data; since the difference between the first candidate original image and the second candidate original image lies in the hairline position, the difference between the first noise data and the second noise data is also the difference in the hairline position, and the noise difference data in turn can characterize a hairline position difference feature between the first noise data and the second noise data; the noise difference data is then subtracted from the first noise data to obtain third noise data, which characterizes the noise data corresponding to the image after the hairline is reversely processed (i.e., moved up). Thereafter, the third noise data is input into the stylegan2 network to generate the first reconstructed image, as shown in FIG. 3 at a; compared with the reconstructed image generated by directly inputting the first noise data into the stylegan2 network, the hairline in the first reconstructed image is relatively bald, and the hairline position is significantly different from that in the second reconstructed image.

After obtaining the first reconstructed image and the second reconstructed image, since there are slight differences in skin color, hair color, shape of facial features, etc. between the first reconstructed image and the second reconstructed image except for the different hairline positions, in order to reduce the interference of the above differences on the neural network training process, a region image of the region where the hairline is located in the second reconstructed image may be determined, and then the region image may be fused with the first reconstructed image to generate a third reconstructed image. The first reconstructed image and the third reconstructed image are determined as a reconstructed image pair. A reconstructed image pair corresponding to each candidate original image pair in turn may be obtained.

The process of determining the region image of the region where the hairline is located in the second reconstructed image is the same as the process of determining the target region information of the region where the hairline is located in the reference original image in S103, and reference may be made to the above detailed description of S103. For the process of fusing the region image of the region where the hairline is located in the second reconstructed image with the first reconstructed image to generate the third reconstructed image, reference may be made to the above detailed description of S104.

As an exemplary explanation, region segmentation processing is performed on the first reconstructed image and the second reconstructed image respectively to generate a first reconstructed segmented image corresponding to the first reconstructed image and a second reconstructed segmented image corresponding to the second reconstructed image. Then, pixel values of the pixel points located below a target reference line in the first reconstructed segmented image and the second reconstructed segmented image are respectively adjusted to a preset value, thus obtaining an adjusted first reconstructed segmented image and an adjusted second reconstructed segmented image. The pixel values at corresponding pixel positions in the adjusted first reconstructed segmented image and the adjusted second reconstructed segmented image are subjected to subtraction, to generate a reconstructed deviation image including the region where the hairline is located. Dilation processing is performed on the region where the hairline is located in the reconstructed deviation image, to generate a processed reconstructed deviation image. A reconstructed mask image is generated according to the first reconstructed segmented image, and the pixel values at corresponding pixel positions in the processed reconstructed deviation image and the reconstructed mask image are multiplied together, to generate a hairline reconstructed segmented image. Based on the region where facial features are located in the first reconstructed segmented image, a target image region including the region where facial features are located is determined, and based on the target image region, a processed first reconstructed segmented image is generated; pixel values at corresponding pixel positions in the processed first reconstructed segmented image and the hairline reconstructed segmented image are multiplied together, to generate an adjusted hairline reconstructed segmented image. A region image of the region where the hairline is located in the second reconstructed image in turn is determined according to the adjusted hairline reconstructed segmented image.

In steps c3 and c4, a plurality of reconstructed image pairs may be determined as training samples, and the neural network to be trained may be trained using the training samples until the trained neural network meets a training cutoff condition, thereby obtaining a target neural network, wherein the training cutoff condition includes the number of times of training being greater than a set number-of-times threshold, a network loss value being less than a set loss threshold, the neural network convergence, etc. The network structure of the neural network to be trained may be a pix2pix network.

For example, the first reconstructed image may be input into the neural network to be trained, to generate a predicted image, the loss value may be determined according to the predicted image and the second reconstructed image, and the network parameters of the neural network to be trained may be adjusted using the loss value, thus performing training to obtain a target neural network, wherein the loss function may be set as needed.

Illustratively, an image processing method is exemplarily described below. First, the process of performing training to obtain a target neural network is explained:
Step 11: acquiring a plurality of candidate original image pairs, wherein each candidate original image pair includes: a first candidate original image, and a second candidate original image obtained after performing hairline adjustment on the first candidate original image.
Step 12: for each candidate original image pair, inputting the first candidate original image into e4e to generate first noise data, and inputting the second candidate original image into e4e to generate second noise data.
Step 13: inputting the second noise data into the stylegan2 network to generate a second reconstructed image. And, in one approach, the first noise data is input into the stylegan2 network to generate a first reconstructed image. In another approach, the second noise data and the first noise data are subjected to subtraction, to obtain noise difference data, and then the first noise data and the noise difference data are subjected to subtraction to obtain third noise data; the third noise data is input into the stylegan2 network to generate a first reconstructed image.
Step 14: performing region segmentation processing on the first reconstructed image and the second reconstructed image respectively using a segmentation tool such as parsing tool, to generate a first reconstructed segmented image corresponding to the first reconstructed image and a second reconstructed segmented image corresponding to the second reconstructed image.
Step 15: adjusting pixel values of the pixel points located below an eyebrow part in the first reconstructed segmented image and the second reconstructed segmented image respectively to zero, to obtain an adjusted first reconstructed segmented image and an adjusted second reconstructed segmented image. The pixel values at corresponding pixel positions in the adjusted first reconstructed segmented image and the adjusted second reconstructed segmented image are subjected to subtraction, to generate a reconstructed deviation image including a region where a hairline is located.
Step 16: performing dilation processing on the region where a hairline is located in the reconstructed deviation image, to generate a processed reconstructed deviation image; generating a reconstructed mask image according to the first reconstructed segmented image, and multiplying pixel values at corresponding pixel positions in the processed reconstructed deviation image and the reconstructed mask image together, to generate a hairline reconstructed segmented image.
Step 17: based on a region where facial features are located in the first reconstructed segmented image, determining a target image region including the region where facial features are located, and based on the target image region, generating a processed first reconstructed segmented image; multiplying pixel values at corresponding pixel positions in the processed first reconstructed segmented image and the hairline reconstructed segmented image together, to generate an adjusted hairline reconstructed segmented image; further, determining a region image of the region where a hairline is located in the second reconstructed image according to the adjusted hairline reconstructed segmented image.
Step 18: fusing the region image of the region where a hairline is located in the second reconstructed image, with the first reconstructed image, to generate a third reconstructed image; determining the first reconstructed image and the third reconstructed image as a reconstructed image pair.
Step 19: determining each reconstructed image pair as a training sample; training the neural network to be trained using the training samples, to obtain a target neural network.

Further, the application process of the target neural network is explained, which specifically includes:
Step 21: acquiring an original image to be processed.
Step 22: performing hairline adjustment on the original image to be processed using the target neural network, to generate a reference original image.
Step 23: performing facial region segmentation processing on the reference original image and the original image to be processed respectively, to generate a first segmented image corresponding to the reference original image and a second segmented image corresponding to the original image to be processed; wherein, in the first segmented image and the second segmented image, pixel values corresponding to different semantic regions are different.
Step 24: adjusting pixel values of the pixel points located below a target reference line in the first segmented image and the second segmented image respectively to a preset value, to obtain an adjusted first segmented image and an adjusted second segmented image, wherein the target reference line is determined based on a target part.
Step 25: subjecting pixel values at corresponding pixel positions in the adjusted first segmented image and the adjusted second segmented image to subtraction, to generate a deviation image including the region where a hairline is located.
Step 26: performing dilation processing on the region where a hairline is located in the deviation image, to generate a processed deviation image; generating a mask image according to the first segmented image, and multiplying pixel values at corresponding pixel positions in the processed deviation image and the mask image together, to generate a hairline segmentation image; pixel values of the regions other than the face and the hair in the mask image are zero.
Step 27: based on a region where facial features are located in the first segmented image, determining a target image region including the region where facial features are located, and based on the target image region, generating a processed first segmented image; in the processed first segmented image, pixel values at pixel positions corresponding to the target image region are zero; multiplying pixel values at corresponding pixel positions in the processed first segmented image and the hairline segmentation image together, to generate an adjusted hairline segmentation image.
Step 28: based on the adjusted hairline segmentation image, determining target region information of the region where a hairline is located in the reference original image, and determining hair color information in the original image to be processed; based on the hair color information, adjusting the hair color of the reference original image, to generate an adjusted reference original image.
Step 29: fusing the target region image in the adjusted reference original image that matches the target region information, with the original image to be processed, to generate a target original image.

Those skilled in the art may appreciate that, in the above method of specific implementation, the order in which the steps are drafted does not imply a strict execution order and does not constitute any limitation on the implementation process. The specific execution order of the steps should be determined by their functions and possible internal logic.

Based on the same inventive concept, the embodiments of the present disclosure further provide an image processing apparatus, which corresponds to the image processing method. Since the principle of solving the problem by the apparatus in the embodiments of the present disclosure is similar to that of the above-mentioned image processing method in the embodiments of the present disclosure, for the implementation of the apparatus, reference may be made to the implementation of the method, which will not be repeated.

Referring to FIG. 4, which is a schematic diagram of the architecture of an image processing apparatus provided by an embodiment of the present disclosure, the apparatus comprises: an acquisition module 401, a first generation module 402, a determination module 403, and a second generation module 404; wherein,
the acquisition module 401 is configured to acquire an original image to be processed;
the first generation module 402 is configured to adjust the original image to be processed to generate a reference original image;
the determination module 403 is configured to determine target region information in the reference original image; and
the second generation module 404 is configured to fuse a target region image in the reference original image that matches the target region information, with the original image to be processed, to generate a target original image.

In some implementations, the determination module 403, when determining target region information in the reference original image, is configured to:
perform region segmentation processing on the reference original image and the original image to be processed respectively, and generating a first segmented image corresponding to the reference original image and a second segmented image corresponding to the original image to be processed; wherein, in the first segmented image and the second segmented image, pixel values corresponding to different semantic regions are different;
determine, based on the first segmented image and the second segmented image, the target region information of a region where a hairline is located in the reference original image.

In some implementations, the determination module 403, when determining, based on the first segmented image and the second segmented image, the target region information of a region where a hairline is located in the reference original image, is configured to:
adjust pixel values of the pixel points located below a target reference line in the first segmented image and the second segmented image respectively to a preset value, to obtain an adjusted first segmented image and an adjusted second segmented image, wherein the target reference line is determined based on a target part;
subject pixel values at corresponding pixel positions in the adjusted first segmented image and the adjusted second segmented image to subtraction, to generate a deviation image including the region where a hairline is located;
determine, based on the deviation image, the target region information of the region where a hairline is located in the reference original image.

In some implementations, the determination module 403, when determining, based on the deviation image, the target region information of the region where a hairline is located in the reference original image, is configured to:
perform dilation processing on the region where a hairline is located in the deviation image, to generate a processed deviation image;
generate a mask image according to the first segmented image;
generate a hairline segmentation image based on the processed deviation image and the mask image;
determine, based on the hairline segmentation image, the target region information of the region where a hairline is located in the reference original image.

In some implementations, the determination module 403, after the generating a hairline segmentation image, is further configured to:
determine, based on a region where facial features are located in the first segmented image, a target image region including the region where facial features are located, and generate, based on the target image region, a processed first segmented image; wherein, in the processed first segmented image, pixel values at pixel positions corresponding to the target image region are zero;
generate an adjusted hairline segmentation image based on the processed first segmented image and the hairline segmentation image;
the determination module 403, when determining, based on the hairline segmentation image, the target region information of the region where a hairline is located in the reference original image, is configured to:
   determine, based on the adjusted hairline segmentation image, the target region information of the region where a hairline is located in the reference original image.

In some implementations, before the fusing a target region image in the reference original image that matches the target region information, with the original image to be processed, the apparatus further comprises an adjustment module 405, which is configured to:
determine hair color information in the original image to be processed;
adjust a hair color of the reference original image based on the hair color information, to generate an adjusted reference original image;
the second generation module 404, when fusing a target region image in the reference original image that matches the target region information, with the original image to be processed, to generate a target original image, is configured to:
   fuse the target region image in the adjusted reference original image that matches the target region information, with the original image to be processed, to generate the target original image.

In some implementations, the first generation module 402, when adjusting the original image to be processed to generate a reference original image, is configured to: adjust the original image to be processed using a target neural network obtained by performing training, to generate the reference original image;

The apparatus further comprises a training module 406, configured to obtain the target neural network by performing training according to the steps of:
acquiring a plurality of candidate original image pairs, wherein each of the candidate original image pairs includes: a first candidate original image, and a second candidate original image obtained after performing hairline adjustment on the first candidate original image;
for each of the candidate original image pairs, determining a first reconstructed image of the first candidate original image and a second reconstructed image of the second candidate original image in the candidate original image pair; and fusing a region image of a region where a hairline is located in the second reconstructed image with the first reconstructed image, to generate a third reconstructed image, and determining the first reconstructed image and the third reconstructed image as a reconstructed image pair;
determining each of the reconstructed image pairs as a training sample;
training the neural network to be trained using the training samples, to obtain the target neural network.

In some implementations, the training module 406, when determining a first reconstructed image of the first candidate original image and a second reconstructed image of the second candidate original image in the candidate original image pair, is configured to:
determine first noise data of the first candidate original image and second noise data of the second candidate original image;
generate the second reconstructed image based on the second noise data; and
generate the first reconstructed image based on the first noise data; or, determine noise difference data between the second noise data and the first noise data, perform difference processing on the first noise data and the noise difference data to obtain third noise data, and generate the first reconstructed image using the third noise data.

For the description of the processing flows of the modules in the apparatus and the interaction flows between the modules, reference may be made to the relevant illustrations in the above method embodiments, which will not be described in detail here.

Based on the same technical concept, the embodiments of the present disclosure further provide a computer device. Referring to FIG. 5, which is a schematic structural diagram of a computer device 500 provided by an embodiment of the present disclosure, the computer device 500 comprises a processor 501, a memory 502, and a bus 503, wherein the memory 502 is configured to store execution instructions and includes an internal memory 5021 and an external memory 5022; the internal memory 5021 is configured to temporarily store the operation data in the processor 501, and the data exchanged with the external memory 5022 such as a hard disk; the processor 501 performs data exchange with the external memory 5022 through the internal memory 5021; when the computer device 500 is running, the processor 501 communicates with the memory 502 through the bus 503, causing the processor 501 to execute the following instructions:
acquiring an original image to be processed;
adjusting the original image to be processed to generate a reference original image; determining target region information in the reference original image; and
fusing a target region image in the reference original image that matches the target region information, with the original image to be processed, to generate a target original image.

In a possible design, in the instructions executed by the processor 501, the determining target region information in the reference original image comprises:
performing region segmentation processing on the reference original image and the original image to be processed respectively, and generating a first segmented image corresponding to the reference original image and a second segmented image corresponding to the original image to be processed; wherein, in the first segmented image and the second segmented image, pixel values corresponding to different semantic regions are different;
determining, based on the first segmented image and the second segmented image, the target region information of a region where a hairline is located in the reference original image.

In a possible design, in the instructions executed by the processor 501, the determining, based on the first segmented image and the second segmented image, the target region information of a region where a hairline is located in the reference original image comprises:
adjusting pixel values of the pixel points located below a target reference line in the first segmented image and the second segmented image respectively to a preset value, to obtain an adjusted first segmented image and an adjusted second segmented image, wherein the target reference line is determined based on a target part;
subjecting pixel values at corresponding pixel positions in the adjusted first segmented image and the adjusted second segmented image to subtraction, to generate a deviation image including the region where a hairline is located;
determining, based on the deviation image, the target region information of the region where a hairline is located in the reference original image.

In a possible design, in the instructions executed by the processor 501, the determining, based on the deviation image, the target region information of the region where a hairline is located in the reference original image comprises:
performing dilation processing on the region where a hairline is located in the deviation image, to generate a processed deviation image;
generating a mask image according to the first segmented image;
generating a hairline segmentation image based on the processed deviation image and the mask image;
determining, based on the hairline segmentation image, the target region information of the region where a hairline is located in the reference original image.

In a possible design, the instructions executed by the processor 501, after the generating a hairline segmentation image, further comprise:
determining, based on a region where facial features are located in the first segmented image, a target image region including the region where facial features are located, and generating, based on the target image region, a processed first segmented image; wherein, in the processed first segmented image, pixel values at pixel positions corresponding to the target image region are zero;
generating an adjusted hairline segmentation image based on the processed first segmented image and the hairline segmentation image;
the determining, based on the hairline segmentation image, the target region information of the region where a hairline is located in the reference original image comprises:
   determining, based on the adjusted hairline segmentation image, the target region information of the region where a hairline is located in the reference original image.

In a possible design, the instructions executed by the processor 501, before the fusing a target region image in the reference original image that matches the target region information, with the original image to be processed, further comprise:
determining hair color information in the original image to be processed;
adjusting a hair color of the reference original image based on the hair color information, to generate an adjusted reference original image;
the fusing a target region image in the reference original image that matches the target region information, with the original image to be processed, to generate a target original image, comprises:
   fusing the target region image in the adjusted reference original image that matches the target region information, with the original image to be processed, to generate the target original image.

In a possible design, in the instructions executed by the processor 501, the adjusting the original image to be processed to generate a reference original image comprises: adjusting the original image to be processed using a target neural network obtained by performing training, to generate the reference original image;
the target neural network is obtained by performing training according to the steps of:
   acquiring a plurality of candidate original image pairs, wherein each of the candidate original image pairs includes: a first candidate original image, and a second candidate original image obtained after performing hairline adjustment on the first candidate original image;
   for each of the candidate original image pairs, determining a first reconstructed image of the first candidate original image and a second reconstructed image of the second candidate original image in the candidate original image pair; and fusing a region image of a region where a hairline is located in the second reconstructed image with the first reconstructed image, to generate a third reconstructed image, and determining the first reconstructed image and the third reconstructed image as a reconstructed image pair;
   determining each of the reconstructed image pairs as a training sample;
   training the neural network to be trained using the training samples, to obtain the target neural network.

In a possible design, in the instructions executed by the processor 501, the determining a first reconstructed image of the first candidate original image and a second reconstructed image of the second candidate original image in the candidate original image pair comprises:
determining first noise data of the first candidate original image and second noise data of the second candidate original image;
generating the second reconstructed image based on the second noise data; and
generating the first reconstructed image based on the first noise data; or, determining noise difference data between the second noise data and the first noise data, performing difference processing on the first noise data and the noise difference data to obtain third noise data, and
generating the first reconstructed image using the third noise data.

The embodiments of the present disclosure further provide a computer-readable storage medium, on which a computer program is stored, and the computer program, when executed by a processor, performs the steps of the image processing method described in the above method embodiments, wherein the storage medium may be a volatile or non-volatile computer-readable storage medium.

The embodiments of the present disclosure further provide a computer program product, which carries program codes, and the instructions included in the program codes can be used to perform the steps of the image processing method described in the above method embodiments. For details, reference may be made to the above method embodiments, which will not be repeated here.

The above-mentioned computer program product may be implemented in the form of hardware, software or a combination thereof. In some embodiments, the computer program product is specifically embodied as a computer storage medium. In some embodiments, the computer program product is specifically embodied as a software product, such as a software development kit (SDK) and the like.

Those skilled in the art can clearly understand that, for the convenience and brevity of description, for the specific working process of the system and device described above, reference may be made to the corresponding process in the aforementioned method embodiments, which will not be repeated here. In several embodiments provided in the present disclosure, it should be understood that the disclosed systems, apparatuses, and methods may be implemented in other ways. The apparatus embodiments described above are merely illustrative. For example, the division of the units is merely a logical function division, and there may be other division methods in actual implementation. For another example, multiple units or components may be combined or integrated into another system, or some features may be ignored or not executed. Another point is that the mutual coupling or direct coupling or communicative connection shown or discussed may be an indirect coupling or communicative connection through some communication interfaces, apparatuses or units, which may be electrical, mechanical or other forms.

The units described as separate components may or may not be physically separated, and the components shown as units may or may not be physical units, that is, they may be located in one place or distributed over multiple network units. Some or all of the units may be selected according to actual needs to achieve the purpose of the solution of this embodiment.

In addition, each functional unit in each embodiment of the present disclosure may be integrated into one processing unit, or each unit may exist physically separately, or two or more units may be integrated into one unit.

If the functions are implemented in the form of software functional units and sold or used as independent products, they can be stored in a processor-executable non-volatile computer-readable storage medium. Based on such understanding, the technical solution of the present disclosure, or the part that contributes to the related art or the part of the technical solution, may essentially be embodied in the form of a software product, and the computer software product is stored on a storage medium and includes a number of instructions for enabling a computer device (which may be a personal computer, a server, or a network device, etc.) to execute all or part of the steps of the method described in each embodiment of the present disclosure. The aforementioned storage medium includes: U disks, mobile hard disks, read-only memory (ROM), random access memory (RAM), magnetic disks or optical disks and other media that can store program codes.

Finally, it should be noted that the above-described embodiments are only specific implementations of the present disclosure, which are used to illustrate the technical solutions of the present disclosure rather than to limit them. The protection scope of the present disclosure is not limited thereto. Although the present disclosure has been described in detail with reference to the aforementioned embodiments, those skilled in the art should understand that any skilled person familiar with the technical field can still modify the technical solutions recorded in the aforementioned embodiments within the technical scope disclosed in the present disclosure, or can easily conceive of changes, or make equivalent replacements for some of the technical features therein. These modifications, changes or replacements do not deviate the essence of the corresponding technical solutions from the spirit and scope of the technical solutions of the embodiments of the present disclosure, and should all be covered by the protection scope of the present disclosure. Therefore, the protection scope of the present disclosure shall be based on the protection scope of the claims.

What is claimed is:

1. An image processing method, comprising:
acquiring an original image to be processed;
adjusting the original image to be processed to generate a reference original image;
determining target region information in the reference original image; and
fusing a target region image in the reference original image that matches the target region information, with the original image to be processed, to generate a target original image.

2. The method according to claim 1, wherein the determining target region information in the reference original image comprises:
performing region segmentation processing on the reference original image and the original image to be processed respectively, and generating a first segmented image corresponding to the reference original image and a second segmented image corresponding to the original image to be processed; wherein, in the first segmented image and the second segmented image, pixel values corresponding to different semantic regions are different;
determining, based on the first segmented image and the second segmented image, the target region information of a region where a hairline is located in the reference original image.

3. The method according to claim 2, wherein the determining, based on the first segmented image and the second segmented image, the target region information of a region where a hairline is located in the reference original image comprises:
adjusting pixel values of the pixel points located below a target reference line in the first segmented image and the second segmented image respectively to a preset value, to obtain an adjusted first segmented image and an adjusted second segmented image, wherein the target reference line is determined based on a target part;
subjecting pixel values at corresponding pixel positions in the adjusted first segmented image and the adjusted second segmented image to subtraction, to generate a deviation image including the region where a hairline is located;
determining, based on the deviation image, the target region information of the region where a hairline is located in the reference original image.

4. The method according to claim 3, wherein the determining, based on the deviation image, the target region information of the region where a hairline is located in the reference original image comprises:
performing dilation processing on the region where a hairline is located in the deviation image, to generate a processed deviation image;
generating a mask image according to the first segmented image;
generating a hairline segmentation image based on the processed deviation image and the mask image;
determining, based on the hairline segmentation image, the target region information of the region where a hairline is located in the reference original image.

5. The method according to claim 4, after the generating a hairline segmentation image, further comprising:
determining, based on a region where facial features are located in the first segmented image, a target image region including the region where facial features are located, and generating, based on the target image region, a processed first segmented image; wherein, in the processed first segmented image, pixel values at pixel positions corresponding to the target image region are zero;
generating an adjusted hairline segmentation image based on the processed first segmented image and the hairline segmentation image;
wherein the determining, based on the hairline segmentation image, the target region information of the region where a hairline is located in the reference original image comprises:
determining, based on the adjusted hairline segmentation image, the target region information of the region where a hairline is located in the reference original image.

6. The method according to claim 1, before the fusing a target region image in the reference original image that matches the target region information, with the original image to be processed, further comprising:
determining hair color information in the original image to be processed;
adjusting a hair color of the reference original image based on the hair color information, to generate an adjusted reference original image;
wherein the fusing a target region image in the reference original image that matches the target region information, with the original image to be processed, to generate a target original image, comprises:
fusing the target region image in the adjusted reference original image that matches the target region information, with the original image to be processed, to generate the target original image.

7. The method according to claim 1, wherein the adjusting the original image to be processed to generate a reference original image comprises:
adjusting the original image to be processed using a target neural network obtained by performing training, to generate the reference original image;
wherein the target neural network is obtained by performing training according to the steps of:
acquiring a plurality of candidate original image pairs, wherein each of the candidate original image pairs includes: a first candidate original image, and a second candidate original image obtained after performing hairline adjustment on the first candidate original image;
for each of the candidate original image pairs, determining a first reconstructed image of the first candidate original image and a second reconstructed image of the second candidate original image in the candidate original image pair; and fusing a region image of a region where a hairline is located in the second reconstructed image with the first reconstructed image, to generate a third reconstructed image, and determining the first reconstructed image and the third reconstructed image as a reconstructed image pair;
determining each of the reconstructed image pairs as a training sample;
training the neural network to be trained using the training samples, to obtain the target neural network.

8. The method according to claim 7, wherein the determining a first reconstructed image of the first candidate original image and a second reconstructed image of the second candidate original image in the candidate original image pair comprises:
determining first noise data of the first candidate original image and second noise data of the second candidate original image;
generating the second reconstructed image based on the second noise data; and
generating the first reconstructed image based on the first noise data; or, determining noise difference data between the second noise data and the first noise data, performing difference processing on the first noise data and the noise difference data to obtain third noise data, and generating the first reconstructed image using the third noise data.

9. A computer device, comprising: a processor, a memory and a bus, wherein the memory stores machine-readable instructions executable by the processor, and when the computer device is running, the processor and the memory communicate via the bus, and the machine-readable instructions, when executed by the processor, perform the steps of an image processing method, comprising:
acquiring an original image to be processed;
adjusting the original image to be processed to generate a reference original image;
determining target region information in the reference original image; and
fusing a target region image in the reference original image that matches the target region information, with the original image to be processed, to generate a target original image.

10. A non-transitory computer-readable storage medium having a computer program stored thereon, wherein the computer program, when executed by a processor, performs the steps of an image processing method, comprising:
acquiring an original image to be processed;
adjusting the original image to be processed to generate a reference original image;
determining target region information in the reference original image; and
fusing a target region image in the reference original image that matches the target region information, with the original image to be processed, to generate a target original image.

11. The computer device according to claim 9, wherein the determining target region information in the reference original image comprises:
performing region segmentation processing on the reference original image and the original image to be processed respectively, and generating a first segmented image corresponding to the reference original image and a second segmented image corresponding to the original image to be processed; wherein, in the first segmented image and the second segmented image, pixel values corresponding to different semantic regions are different;
determining, based on the first segmented image and the second segmented image, the target region information of a region where a hairline is located in the reference original image.

12. The computer device according to claim 11, wherein the determining, based on the first segmented image and the second segmented image, the target region information of a region where a hairline is located in the reference original image comprises:
adjusting pixel values of the pixel points located below a target reference line in the first segmented image and the second segmented image respectively to a preset value, to obtain an adjusted first segmented image and an adjusted second segmented image, wherein the target reference line is determined based on a target part;
subjecting pixel values at corresponding pixel positions in the adjusted first segmented image and the adjusted second segmented image to subtraction, to generate a deviation image including the region where a hairline is located;
determining, based on the deviation image, the target region information of the region where a hairline is located in the reference original image.

13. The computer device according to claim 12, wherein the determining, based on the deviation image, the target region information of the region where a hairline is located in the reference original image comprises:
performing dilation processing on the region where a hairline is located in the deviation image, to generate a processed deviation image;
generating a mask image according to the first segmented image;
generating a hairline segmentation image based on the processed deviation image and the mask image;
determining, based on the hairline segmentation image, the target region information of the region where a hairline is located in the reference original image.

14. The computer device according to claim 13, after the generating a hairline segmentation image, further comprising:
determining, based on a region where facial features are located in the first segmented image, a target image region including the region where facial features are located, and generating, based on the target image region, a processed first segmented image; wherein, in the processed first segmented image, pixel values at pixel positions corresponding to the target image region are zero;
generating an adjusted hairline segmentation image based on the processed first segmented image and the hairline segmentation image;
wherein the determining, based on the hairline segmentation image, the target region information of the region where a hairline is located in the reference original image comprises:
determining, based on the adjusted hairline segmentation image, the target region information of the region where a hairline is located in the reference original image.

15. The computer device according to claim 9, before the fusing a target region image in the reference original image that matches the target region information, with the original image to be processed, further comprising:
determining hair color information in the original image to be processed;
adjusting a hair color of the reference original image based on the hair color information, to generate an adjusted reference original image;
wherein the fusing a target region image in the reference original image that matches the target region information, with the original image to be processed, to generate a target original image, comprises:
fusing the target region image in the adjusted reference original image that matches the target region information, with the original image to be processed, to generate the target original image.

16. The non-transitory computer-readable storage medium according to claim 10, wherein the determining target region information in the reference original image comprises:
performing region segmentation processing on the reference original image and the original image to be processed respectively, and generating a first segmented image corresponding to the reference original image and a second segmented image corresponding to the original image to be processed; wherein, in the first segmented image and the second segmented image, pixel values corresponding to different semantic regions are different;
determining, based on the first segmented image and the second segmented image, the target region information of a region where a hairline is located in the reference original image.

17. The non-transitory computer-readable storage medium according to claim 16, wherein the determining, based on the first segmented image and the second segmented image, the target region information of a region where a hairline is located in the reference original image comprises:
adjusting pixel values of the pixel points located below a target reference line in the first segmented image and the second segmented image respectively to a preset value, to obtain an adjusted first segmented image and an adjusted second segmented image, wherein the target reference line is determined based on a target part;
subjecting pixel values at corresponding pixel positions in the adjusted first segmented image and the adjusted second segmented image to subtraction, to generate a deviation image including the region where a hairline is located;
determining, based on the deviation image, the target region information of the region where a hairline is located in the reference original image.

18. The non-transitory computer-readable storage medium according to claim 17, wherein the determining, based on the deviation image, the target region information of the region where a hairline is located in the reference original image comprises:
performing dilation processing on the region where a hairline is located in the deviation image, to generate a processed deviation image;
generating a mask image according to the first segmented image;
generating a hairline segmentation image based on the processed deviation image and the mask image;
determining, based on the hairline segmentation image, the target region information of the region where a hairline is located in the reference original image.

19. The non-transitory computer-readable storage medium according to claim 18, after the generating a hairline segmentation image, further comprising:
determining, based on a region where facial features are located in the first segmented image, a target image region including the region where facial features are located, and generating, based on the target image region, a processed first segmented image; wherein, in the processed first segmented image, pixel values at pixel positions corresponding to the target image region are zero;
generating an adjusted hairline segmentation image based on the processed first segmented image and the hairline segmentation image;
wherein the determining, based on the hairline segmentation image, the target region information of the region where a hairline is located in the reference original image comprises:
determining, based on the adjusted hairline segmentation image, the target region information of the region where a hairline is located in the reference original image.

20. The non-transitory computer-readable storage medium according to claim 10, before the fusing a target region image in the reference original image that matches the target region information, with the original image to be processed, further comprising:
determining hair color information in the original image to be processed;
adjusting a hair color of the reference original image based on the hair color information, to generate an adjusted reference original image;
wherein the fusing a target region image in the reference original image that matches the target region information, with the original image to be processed, to generate a target original image, comprises:
fusing the target region image in the adjusted reference original image that matches the target region information, with the original image to be processed, to generate the target original image.
